(19) United States
(12) Patent Application Publication
(10) Pub. No.: US 2026/0034386 A1
(43) Pub. Date: Feb. 5, 2026

(54) A SYSTEM FOR SUPPLYING A BREATHABLE GAS TO A USER

(71) Applicant: AVIATION WORKS LIMITED, London (GB)

(72) Inventors: Robert Boyle, London (GB); Cristina Vázquez Reynel, London (GB); Pablo Reguera Duran, London (GB)

(21) Appl. No.: 18/997,715

(22) PCT Filed: Jul. 26, 2023
(86) PCT No.: PCT/EP2023/070707

§ 371 Date: Jan. 22, 2025

(30) Foreign Application Priority Data
Jul. 29, 2022 (EP) 22187837.4

(51) Int. Cl. A62B 7/02; A62B 9/02; A62B 9/04; B64D 11/00

(52) U.S. Cl. CPC A62B 7/02; A62B 9/02; A62B 9/04; B64D 11/00

(57) ABSTRACT

A system for supplying a breathable gas to a user comprises: at least one face mask comprising: a gas feed tube for connection to a vessel containing a supply of breathable gas; and a control system for controlling a flow of the breathable gas from the vessel when the gas feed tube is connected thereto and the control system is in an operative condition; a holder for holding the at least one face mask in a location in space while the control system is in a non-operative condition; and an activation device responsive to displacement of the at least one face mask away from the location in space, so as to activate the flow of the breathable gas from the vessel and to activate the operative condition of the control system, thereby to activate a controllable flow of the breathable gas to the user.

### FIELD OF THE INVENTION

The present invention relates to a system for supplying a breathable gas to a user, for example in the environment of an aircraft cabin.

### BACKGROUND

Modern passenger aircraft carry oxygen systems for providing breathable oxygen to passengers and crew in the event of an emergency, such as sudden depressurisation of the aircraft cabin.

Currently, the most modern passenger emergency oxygen systems comprise a single control system shared by multiple face masks. This means that failure of the single control system leads to the loss of function of multiple face masks. The risk of multiple fatalities, resulting from the failure of a single control system, drives system complexity and requires complex high levels of system redundancy, such that multiple fatalities may be avoided in the event of a single control system failure.

The requirement for highly complex control systems, coupled with valves to supply multiple passengers, mean that the system requires a comparatively high level of power to function, necessitating connection to the aircraft power supply. This makes installation more expensive and retrofitting to existing aircraft, more challenging.

The complex systems may also be maintenance-intensive. The oxygen supply will leak over time, and therefore there must be a robust shut-off valve installed in the system, without which there will not be enough oxygen for passengers to breathe (or the maintenance intervals will need to be short). Splitting the location of the oxygen supply and the central control system introduces a challenge, of how to activate the system with a single and simple motion of pulling the dropped face mask towards the passenger, as is required by the aviation regulations.

Furthermore, any sensors that are provided in the face mask, for the purpose of determining breathing characteristics for input into the central control system, must be connected to the control system by long wires. The wires may act like aerials to cause electromagnetic interference with other systems of the aircraft, possibly posing a risk to aircraft safety.

The present invention aims to alleviate at least to some extent these problems of current emergency oxygen systems.

### SUMMARY OF INVENTION

According to an aspect of the invention, there is provided a system for supplying a breathable gas to a user, comprising: at least one face mask comprising: a gas feed tube for connection to a vessel containing a supply of breathable gas; and a control system for controlling a flow of the breathable gas from the vessel when the gas feed tube is connected thereto and the control system is in an operative condition; a holder for holding or supporting the at least one face mask in a location in space while the control system is in a non-operative condition; and an activation device responsive to displacement of the at least one face mask away from the location in space, so as to activate the flow of the breathable gas from the vessel and to activate the operative condition of the control system, thereby to activate a controllable flow of the breathable gas to the user.

As used herein, a breathable gas means a gas suitable for inhalation by a human being for sustaining life and normal bodily function. Such breathable gases include pure oxygen, or oxygen mixed with one or more other gases such as nitrogen and/or carbon dioxide, at such concentrations as to be capable of sustaining life and normal bodily function.

Locating the control system in the face mask means that the control system can be simpler and lower power, since the control system only needs to meet the design safety criteria to keep one person (user) alive, not multiple persons.

Furthermore, placing the control system in the face mask eliminates the need for long sensor wires between the face mask and a remotely-located central control system, thereby reducing the risk of electromagnetic interference with other aircraft systems.

The inventive system also meets the aviation regulations, in that both the control system and the flow of breathable gas are activable in response to displacement of the face mask, by a single action of moving (e.g. pulling) the face mask towards the user.

The at least one face mask may comprise an electrical power unit arranged to supply a power circuit of the control system, the electrical power unit preferably comprising an energy storage device, more preferably a battery, still more preferably a lithium battery.

As has been mentioned herein above, locating the control system in the face mask reduces the control system power demand, in comparison with a central control system for controlling multiple face masks. This means that battery power becomes a viable option for the control system. Battery power may be especially desirable because it means that the system can be more easily retrofitted into an aircraft, without modification of the aircraft wiring. It also reduces the electrical demand on the electrical system of the aircraft.

The holder may comprise a line for suspending the at least one face mask in the location in space; and the activation device may comprise: an opening mechanism connected to a first portion of the line and arranged to open a valve part of the vessel; and a switch connected to a second portion of the line and arranged to engage the power circuit of the control system, and wherein the at least one face mask is held suspended by the line in the location in space while the control system is in the non-operative condition, and wherein the at least one face mask is displaceable away from the location in space by an application of a pulling force to tension the line to: move the switch to energise the power circuit of the control system, thereby to activate the operative condition of the control system; and move the opening mechanism, thereby to activate the flow of the breathable gas from the vessel.

The system may comprise: an electrical power unit including a power circuit; and an electrical cable having a first portion connected to the power circuit and a second portion connected to the control system.

The holder may comprise a line for suspending the at least one face mask in the location in space; and the activation device may comprise: an opening mechanism connected to a first portion of the line and arranged to open a valve part of the vessel; a switch connected to a second portion of the line and arranged to engage the power circuit of the electrical power unit; and a third portion of the line connected to the at least one face mask, and wherein the at least one face mask is held suspended by the line in the location in space while the control system is in the non-operative condition, and wherein the at least one face mask is displaceable away from the location in space by an application of a pulling force to tension the line to: move the switch to energise the power circuit of the electrical power unit and the electrical cable, thereby to activate the operative condition of the control system; and move the opening mechanism, thereby to activate the flow of the breathable gas from the vessel.

The holder may comprise a line for suspending the at least one face mask in the location in space; and the activation device may comprise: an electromechanical valve arranged to open the vessel and in electrical connection with the power circuit of the electrical power unit; a switch connected to a first portion of the line and arranged to engage the power circuit of the electrical power unit; and a second portion of the line connected to the at least one face mask, and wherein the at least one face mask is held suspended by the line in the location in space while the control system is in the non-operative condition, and wherein the at least one face mask is displaceable away from the location in space by an application of a pulling force to tension the line to move the switch, to energise the power circuit of the electrical power unit and the electrical cable and the electrical connection to the electromechanical valve, thereby to activate the operative condition of the control system and the flow of the breathable gas from the vessel.

The holder may comprise a container for holding the at least one face mask in the location in space; and the activation device may comprise: an opening mechanism connected to a first portion of a line and arranged to open a valve part of the vessel; and a switch connected to a second portion of the line and arranged to engage the power circuit of the control system, and wherein the at least one face mask is held by the container in the location in space while the control system is in the non-operative condition, and wherein the at least one face mask is displaceable away from the location in space by an application of a pulling force to tension the line to: move the switch to energise the power circuit of the control system, thereby to activate the operative condition of the control system; and move the opening mechanism, thereby to activate the flow of the breathable gas from the vessel.

The holder may comprise a container for holding the at least one face mask in the location in space; and the activation device may comprise: an opening mechanism connected to a first portion of a line and arranged to open a valve part of the vessel; a switch connected to a second portion of the line and arranged to engage the power circuit of the electrical power unit; and a third portion of the line connected to the at least one face mask, and wherein the at least one face mask is held by the container in the location in space while the control system is in the non-operative condition, and wherein the at least one face mask is displaceable away from the location in space by an application of a pulling force to tension the line to: move the switch to energise the power circuit of the electrical power unit and the electrical cable, thereby to activate the operative condition of the control system; and move the opening mechanism, thereby to activate the flow of the breathable gas from the vessel.

The holder may comprise a container for holding the at least one face mask in the location in space; and the activation device may comprise: an electromechanical valve arranged to open the vessel and in electrical connection with the power circuit of the electrical power unit; a switch connected to a first portion of a line and arranged to engage the power circuit of the electrical power unit; and a second portion of the line connected to the at least one face mask, and wherein the at least one face mask is held by the container in the location in space while the control system is in the non-operative condition, and wherein the at least one face mask is displaceable away from the location in space by an application of a pulling force to tension the line to move the switch, to energise the power circuit of the electrical power unit and the electrical cable and the electrical connection to the electromechanical valve, thereby to activate the operative condition of the control system and the flow of the breathable gas from the vessel.

The line may be configured to break under the application of the pulling force, so as to enable the displacement of the at least one face mask away from the location in space; and a magnitude of the pulling force required to break the line may be greater than a magnitude of the pulling force required to activate the operative condition of the control system and the flow of the breathable gas from the vessel, so as to ensure the activation of the operative condition of the control system and the flow of the breathable gas by the displacement of the at least one face mask away from the location in space.

The line may comprise a stronger portion having a higher ultimate tensile strength and a weaker portion having a lower ultimate tensile strength, the weaker portion being breakable under the application of the pulling force.

The system may comprise the vessel.

The breathable gas may comprise oxygen, preferably pure oxygen.

The system may comprise a plurality of the face masks.

According to the present disclosure, there is provided an aircraft comprising a system as described herein above.

According to another aspect of the invention, there is provided a face mask for use in a system as described herein above, the face mask comprising: the gas feed tube for connection to the vessel containing a supply of the breathable gas; and the control system for controlling the flow of the breathable gas from the vessel when the gas feed tube is connected thereto and the control system is in an operative condition.

The face mask may comprise the line.

The face mask may comprise the electrical power unit arranged to supply the power circuit of the control system.

The system described herein is suitable for use with face masks or ventilation masks as described by the applicant's publication WO 2021/224226, which is incorporated herein by reference in its entirety.

### BRIEF DESCRIPTION OF DRAWINGS

Examples will now be described with reference to the accompanying figures, in which:

FIG. 1 is a schematic diagram showing a first example of a system for supplying a breathable gas to a user;

FIGS. 2a and 2b show details of a face mask of the system of FIG. 1;

FIG. 3 is a schematic diagram showing a second example of a system for supplying a breathable gas to a user; and

FIG. 4 is a schematic diagram showing a third example of a system for supplying a breathable gas to a user.

### DETAILED DESCRIPTION

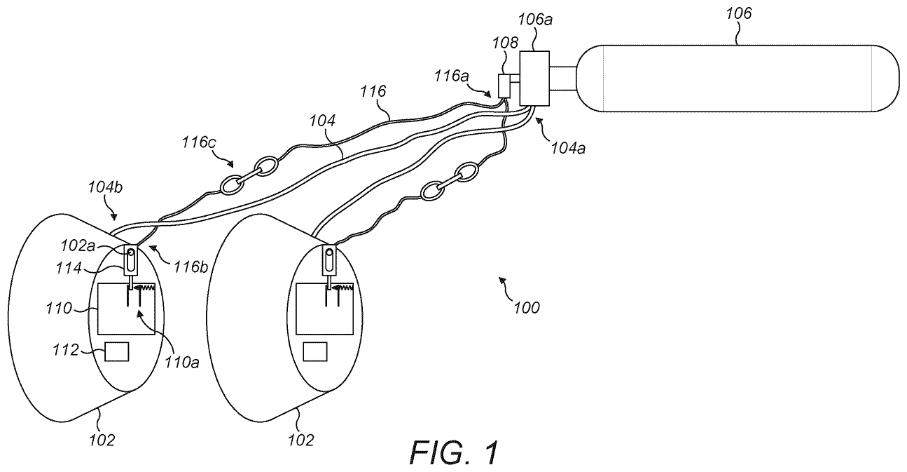

FIG. 1 shows a first example of a system 100 for supplying a breathable gas to a user. In this first example, the system 100 is for supplying breathable gas to passengers and/or crew on-board an aircraft, such as a large passenger airliner.

The system 100 comprises face masks 102 each connected to a source of the breathable gas by a gas feed tube 104. Each face mask 102 comprises a body or cup constructed and shaped to generally conform to the face of a user. The body may be constructed from any suitable material, for example a silicone material. While FIG. 1 shows two face masks 102, the system 100 may comprise any number of the face masks 102 for supplying the breathable gas to multiple users. The face masks 102 of the system 100 are identical to each other and, for the sake of brevity, only one of the face masks 102 and its related components of the system 100 will be described herein below. However, it will be understood that the description is applicable to each of the face masks 102 of the system 100.

In this first example, the source of the breathable gas is a pressurised gas bottle or canister 106 having a valve part 106a. The gas canister 106 may be constructed from any suitable material, for example a metal or metal alloy such as steel or aluminium alloy. A first end portion 104a of the gas feed tube 104 is connected or attached to the valve part 106a of the gas canister 106. A second end portion 104b of the gas feed tube 104 is connected or attached to the body of the face mask 102. In this first example, the gas feed tube 104 is constructed from a soft, plastics material such as to be flexible. In this first example, the gas canister 106 is suitable for storage in the passenger cabin of an aircraft.

The system 100 includes an opening mechanism 108 configured to move or actuate the valve part 106a from a closed position to an open position in order to release a flow of the breathable gas from the canister 106 to the face mask 102, as will be described later herein. In this first example, the gas contained in the gas canister 106 is oxygen, more particularly pure oxygen. In this first example, the opening mechanism 108 is constructed integrally with the valve part 106a. In another example, the opening mechanism 108 and the valve part 106a are constructed separately as discrete elements and are configured to engage with each other.

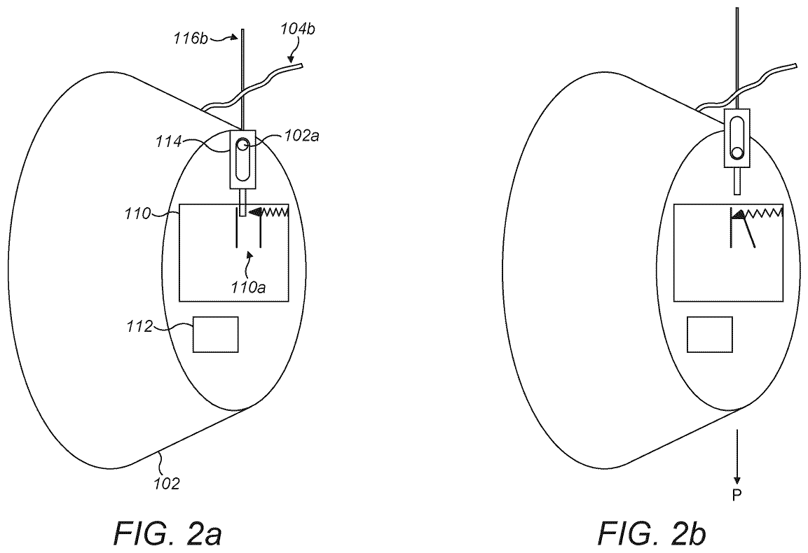

Referring now also to FIG. 2a, the face mask 102 comprises a control system 110 for controlling a flow of the breathable gas from the canister 106. In this first example, the control system 110 comprises an electrical power circuit 110a including a spring-loaded switchable part.

The face mask 102 further comprises an electrical power unit 112 arranged to supply electrical power to the power circuit 110a of the control system 110. In this first example, the electrical power unit 112 comprises an energy storage device, more particularly a battery, still more particularly a lithium battery.

As can be seen in FIG. 2a, in this first example the face mask 102 further comprises a pin element 102a which is fixedly attached to (or alternatively is integrally formed with) the body of the face mask 102. A slidable plug 114 comprises an elongate slot configured to receive the pin element 102a, and a protrusion arranged to engage the spring-loaded switchable part of the power circuit 110a of the control system 110. The protrusion comprises a non-conductive material, such as to prevent the flow of electrical energy through the power circuit 110a when engaged therewith. Thus, as shown in FIG. 2a, the control system 110 is unpowered such as to be in a non-operative condition.

Referring again to FIG. 1, a line 116, e.g. a lanyard or a cord, extends between the face mask 102 and the opening mechanism 108 of the valve part 106a of the gas canister 106. A first portion 116a of the line 116 is connected or attached to the opening mechanism 108. A second portion 116b of the line 116 is connected or attached to the slidable plug 114. In this first example, the line 116 is constructed from a flexible plastics material. The line 116 and its connections/attachments are capable of holding the face mask 102 in suspension, under the gravitational weight of the face mask 102. When the face mask 102 is so suspended, the fully extended length of the line 116 is less than a fully extended length of the gas feed tube 104.

The line 116 comprises a weakened portion 116c located between the first and second portions 116a, 116b. The weakened portion 116c has a lower ultimate tensile strength than does the rest of the line 116. The lower ultimate tensile strength may be provided by any suitable means. For example, the weakened portion may be constructed from a material having a lower tensile strength and the remainder of the line 116 may be constructed from a different material having a higher tensile strength. Alternatively, the line 116 may be constructed from a single material having a variable cross-sectional area along its length, the cross-sectional area being smaller at the weakened portion 116c and greater along the remainder of the line 116.

The operation of the system 100 will now be described. The description will again be limited to one of the face masks 102, but it will be understood that the description is applicable to each of the face masks 102 of the system 100.

Initially, the face mask 102 is stowed behind an overhead panel in a ceiling of an aircraft passenger cabin (or some other overhead structure, such as the underside of the passenger luggage compartments). As is conventional, the overhead panel is configured to be automatically opened to release the face mask 102 in the event of an aircraft depressurisation. The gas canister 106 may also be located in the vicinity of the overhead panel, or may be located remotely from the face mask 102 in a different part of the aircraft.

Upon release the face mask 102 falls downwardly, toward a passenger of the aircraft who is seated beneath the overhead panel. The face mask 102 continues to fall until the line 116 becomes fully extended such as to arrest the fall. Thus the face mask 102 is suspended from the opening mechanism 108 by the line 116, under its own gravitational weight, such as to be held in a first location in space above the passenger's head. A tensile force F will exist in the line 116 as the taut line 116 supports the hanging face mask 102. While the face mask 102 is deployed in this first location in space, the control system 110 is unpowered and is therefore in the non-operative condition.

Turning now to FIG. 2b, the passenger reaches up and grasps the face mask 102 by hand. The passenger applies a downward pull P on the face mask 102, in order to move the face mask 102 away from the first location in space and toward the passenger's face. The pulling motion applied by the passenger to the hanging face mask 102 causes an increase in the tensile force F in the line 116. As the pulling motion progresses a frictional resistance, between the pin element 102a and the internal surfaces of the slot of the slidable plug 114, is overcome so that the face mask 102 (and the fixedly attached pin element 102a) move downwardly relative to the slider bock 114.

Thus, the face mask 102 is moved or displaced (generally downwardly) away from the first location in space. As a result of this displacement of the face mask 102, the protrusion of the slidable plug 114 disengages from the spring-loaded switchable part of the power circuit 110a of the control system 110, thereby causing the spring-loaded switchable part to close so as to complete the power circuit 110a. Thus, the control system 110 is energised by the electrical power unit 112, so as to change the control system 110 from the non-operative condition to an operative condition.

Also as the pulling motion progresses, the tensile force F in the line 116 is transmitted to the opening mechanism 108, thereby to cause the valve part 106a of the gas canister 106 to be moved from the closed position to the open position. Accordingly, a flow of the oxygen is released from the gas canister 106 into the gas feed tube 104 toward to face mask 102.

In this way, a controllable flow of the oxygen is supplied to the face mask 102.

Since each face mask 102 of the system 100 is connected to the opening mechanism 108 via a respective line 116, the displacement of any one of the face masks 102 will activate the oxygen flow to all of the face masks 102, but will activate the control system 110 of only said any one of the face masks 102.

Thus it will be understood that each one of the control system 110 and the opening mechanism 108 is activated in response to the displacement of the face mask 102 away from the first location in space, the displacement being caused by the pulling motion applied to the face mask 102 by the passenger. Furthermore, the pin element 102a, the slidable plug 114, the connecting portions 116a, 116a of the line 116, and the opening mechanism 108 may be said together to comprise an activation device of the system 100.

The distance of a portion of the displacement to enable activation is short, for example about 10 mm. Depending on the level of resistance to movement, of the slidable plug 114 relative to the pin element 102a and of the opening mechanism 108, activation of the opening mechanism 108 may occur immediately before activation of the control system 110, or immediately afterward, or at substantially the same time.

The seated passenger will continue to pull downwardly on the face mask 102 in order to move the face mask 102 to the passenger's face. The continued pulling motion will cause the tensile force F in the line 116 to exceed the ultimate tensile strength of the weakened portion 116c of the line 116, thereby causing the weakened portion 116c to break. It will be recalled that the fully extended length of the line 116 is less than the fully extended length of the gas feed tube 104. Furthermore, the gas feed tube 104 is sufficiently long to be capable of extension to reach the seated passenger's face. Thus, having severed the line 116 at the weakened portion 116c, the passenger is able to further move the face mask 102 down to face level, i.e. to a second location in space that is closer to the passenger than is the first location in space.

The pulling force required to break the weakened portion 116c is greater than the pulling force required to activate the control system 110 and the opening mechanism 108, thereby ensuring that the control system 110 is already in the operative condition and the oxygen is flowing to the face mask 102 when the face mask 102 reaches face level. In this way, the controllable flow of oxygen is certain to be available at the moment the passenger places the face mask 102 on the passenger's face. The pulling force required to activate the control system 110 and the opening mechanism 108 may be in the nominal range 13 to 44 N. The pulling force required to break the weakened portion 116c of the line 116 may be in the nominal range 45 to 60 N.

It will therefore be understood that the breakage of the weakened portion 116c of the line 116 will occur at a moment in time immediately after the activation of the control system 110 and the opening mechanism 108 (which may occur simultaneously or sequentially). However, the passenger will perceive the activations and the breakage as occurring substantially simultaneously and as being part of a single action of movement, since they occur at relatively low forces over a relatively short distance, under the pulling action applied to the face mask 102 by the passenger. The passenger will perceive the movement of the face mask 102, from the first location in space down to face level (second location in space), as resulting from a smooth, single-action, pulling motion requiring only a small amount of effort from the passenger.

The face mask 102 may comprise an indicator light or other visual or audible means, to confirm to the user the activation of the control system 110 into the operative condition.

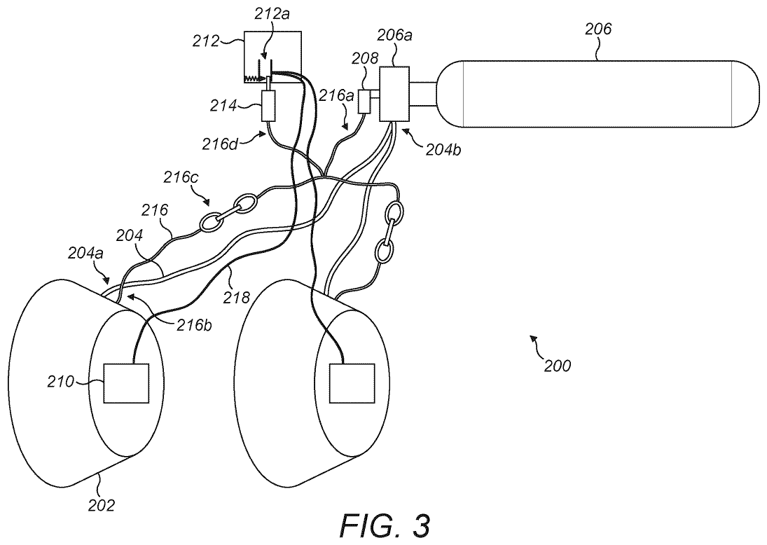

Turning now to FIG. 3, there is shown a second example of a system 200 for supplying a breathable gas to a user. The second example differs from the first example, in that the second example omits the individual power units of each face mask 102 and instead comprises a central power unit 212, for supplying electrical energy to the control system 110 of each face mask 102 of the system 200. In this second example, the central power unit 212 forms an integral part of the electrical system of the aircraft. In another example, the central power unit 212 comprises a separate energy storage device, for example a battery such as a lithium battery.

The central power unit 212 comprises an electrical power circuit 212a including a spring-loaded switchable part. An electrical wire or cable 218 extends between the central power unit 212 and the control system 210 of the face mask 202. The fully extended length of the electrical cable 218 is greater than that of the line 216, and is approximately equal to that of the gas feed tube 204. Optionally, the electrical cable 218 is integrated with the gas feed tube 204. For example, the electrical cable 218 may be embedded in the wall of the gas feed tube 204.

A plug 214 comprises a protrusion arranged to engage the spring-loaded switchable part of the power circuit 212a of the central power unit 212. The protrusion comprises a non-conductive material, such as to prevent the flow of electrical energy through the power circuit 212a when engaged therewith. Thus, as shown in FIG. 3, the control system 210 of the face mask 202 is unpowered such as to be in a non-operative condition.

Also in this second example: a first portion 216a of the line 216 is connected or attached to the opening mechanism 208; a second portion 216b of the line 216 is connected or attached to the body of the face mask 202; and a third portion 216d of the line 216 is connected or attached to the plug 214.

The operation of the system 200 is generally similar to that described herein above in connection with the first example, except in respect of the activation of the control system 210 of the face mask 202, as follows.

The pulling force is applied by the passenger to the hanging face mask 202 and is transmitted to the plug 214 via the line 216, thereby to cause the protrusion of the plug 214 to disengage from the spring-loaded switchable part of the power circuit 212a of the control system 110, in turn to cause the spring-loaded switchable part to close so as to complete the power circuit 212a. Accordingly, electrical energy is transmitted to the control system 210 via the electrical cable 218, thereby to change the control system 210 from a non-operative condition to an operative condition.

Since each face mask 202 of the system 200 is connected to the opening mechanism 208 via a respective line 216, the displacement of any one of the face masks 202 will activate the oxygen flow to all of the face masks 202. Furthermore, since each face mask 202 of the system 200 is connected to the power circuit 212a of the central power unit 212 via a respective electrical cable 218, the displacement of any one of the face masks 202 will activate the control system 210 of each of the face masks 202.

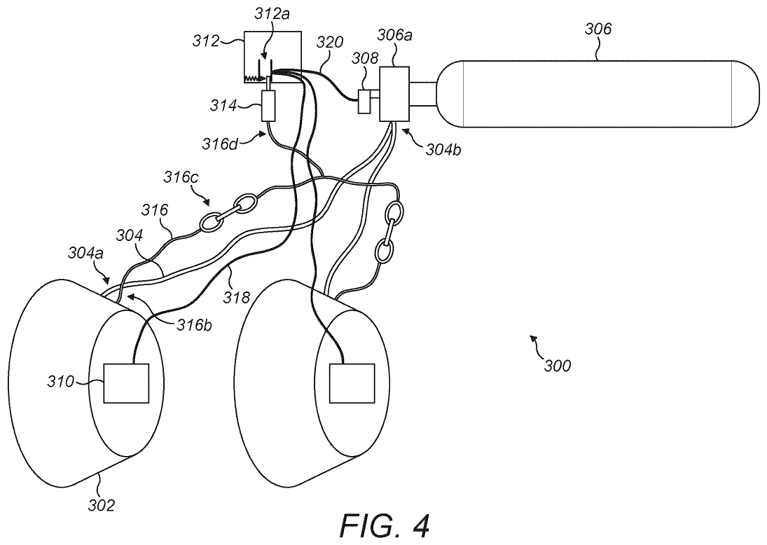

Referring now to FIG. 4, there is shown a third example of a system 300 for supplying a breathable gas to a user. The third example differs from the second example, in that the third example omits a mechanical connection of the line 316 to the opening mechanism 308 and instead comprises an electrical connection for actuating the opening mechanism 308. Thus, in the third example the opening mechanism 308 comprises a solenoid valve connected to the electrical power circuit 312a of the central power unit 312 by an electrical cable 320.

The operation of the system 300 is generally similar to that described herein above in connection with the second example, except in respect of the activation of the opening mechanism 308 to provide the flow of oxygen from the gas canister 306, as follows.

The closure of the spring-loaded switchable part, to complete the power circuit 312a, additionally causes electrical energy to be transmitted to the solenoid valve via the electrical cable 320, thereby to activate the opening mechanism 308 so as to cause the flow of oxygen from the gas canister 306 to the face mask 302.

Since the solenoid valve is responsive to the displacement of any one of the face masks 302, the solenoid valve will activate the oxygen flow to all of the face masks 302.

In the above-described examples, the system may comprise an altitude sensor configured to determine altitude information. The control system may be configured to receive the altitude information from the altitude sensor, and further be configured to control the flow of the oxygen through the gas feed tube based on the received altitude information. The face mask may comprise a valve arranged to be opened and closed to receive a pulsed supply of the oxygen. The face mask may comprise a rebreather bag, for receiving carbon dioxide exhaled by the user.

The altitude sensor may comprise a pressure sensor. This provides a simple means of determining the altitude at which the system is operating. The pressure sensor may be arranged to determine the pressure of the ambient air and be further configured to send the ambient air pressure to the control system. In this case, the altitude at which the system is operating is determined based on the pressure of the ambient air surrounding the system.

In the above-described examples, a circuit of the control system or a circuit of the power unit comprises a switchable part, for completing the circuit upon removal of a plug upon the displacement of the face mask. However, it will be understood that completion of the circuit may be achieved using a variety of alternative switching mechanisms. For example, while in the described examples a non-conductive part is withdrawn in order to complete the electrical circuit, in another example electrical contacts of the circuit may be “open” and a movable conductive part may be inserted to “close” the contacts to complete the circuit. Or, completion of the circuit may be achieved by entirely different means. Thus, in some examples, the system comprises a strain gauge for connection to the line, the strain gauge being responsive to a pulling force on the line to trigger the transmission of a signal (e.g. wirelessly or via a connecting wire) to the control system in the face mask, in order to change the control system from a non-operating condition to an operating condition.

While in the above-described examples the line includes a weakened portion, in other examples the weakened portion is omitted. In such examples, the line is configured to be of sufficient length to enable the face mask to reach the level of the seated passenger's face, activation of the control system and the oxygen flow occurring when the line is pulled taut to face level.

While in the above-described examples the system includes a suspended line for holding the face mask in the first location in space, in other examples the holding function is achieved by other means. For example, the face mask may comprise a magnetic element for magnetic attachment to a fixed support in order to hold the face mask in the first location in space. In such examples, displacement of the mask away from the first location in space, by separation of the face mask from the magnet due to a pulling force applied by the user, may cause the transmission of one or more signals (e.g. wirelessly or via a connecting wire) to: the control system in the face mask, in order to change the control system from a non-operating condition to an operating condition; and the opening mechanism of the valve part of the gas canister, in order to activate the flow of gas to the face mask. In another example, the face mask is held in a container or compartment, provided for instance in a seat-back that faces the passenger, or in a wall of an aircraft such as the wall of a toilet cubicle. The face mask is connected to a line, as has been described herein above. In the event of aircraft depressurisation, a door of the container or compartment may be opened and the passenger may pull on the face mask so as to tauten the line in order to activate the system. In this example, the face mask is not initially held suspended by the line, but rather is held or supported at the first location in space by the container or compartment, or some surface or structural feature thereof. Prior to the application of the pulling force, the line may initially be in an extended condition or in a slack condition. All such arrangements are within the scope of the claimed invention, provided that activation of the operative condition of the control system and the flow of the breathable gas occurs in response to displacement of the face mask away from the first location in space.

It will be understood that some parts of the system may form a part of the aircraft to which the system is fitted, or alternatively may be separate and distinct from the aircraft itself and suitable for installation therein. For example, the gas canister may be part of an existing gas supply of the aircraft, or it may be a separate item which replaces an existing gas supply of the aircraft. The control system in the face mask may be provided with electrical power from an external source, which may form an integral part of an electrical system of the aircraft. Or, the external power source may be a separate power unit suitable for installation in the aircraft. While in the above-described examples the system has been described in the context of use by a passenger on-board an aircraft, it will of course be understood that the system could equally be used by aircraft crew members or other persons, including in connection with military aircraft. Furthermore, the system has a variety of applications other than aviation, including but not limited to medical emergency equipment (e.g. a resuscitation mask in an ambulance or hospital) and oxygen masks used in confined spaces (e.g. submarines or mining).

It should be understood that the invention has been described in relation to its preferred embodiments and may be modified in many different ways without departing from the scope of the invention as defined by the accompanying claims.

1. A system for supplying a breathable gas to a user, comprising:
at least one face mask comprising:
a gas feed tube for connection to a vessel containing a supply of breathable gas; and
a control system for controlling a flow of the breathable gas from the vessel when the gas feed tube is connected thereto and the control system is in an operative condition;
a holder for holding the at least one face mask in a location in space while the control system is in a non-operative condition; and
an activation device responsive to displacement of the at least one face mask away from the location in space, so as to activate the flow of the breathable gas from the vessel and to activate the operative condition of the control system, thereby to activate a controllable flow of the breathable gas to the user.

2. The system according to claim 1, wherein the at least one face mask comprises an electrical power unit arranged to supply a power circuit of the control system, the electrical power unit preferably comprising an energy storage device, more preferably a battery, still more preferably a lithium battery.

3. The system according to claim 2, wherein:
the holder comprises a line for suspending the at least one face mask in the location in space; and
the activation device comprises:
an opening mechanism connected to a first portion of the line and arranged to open a valve part of the vessel; and
a switch connected to a second portion of the line and arranged to engage the power circuit of the control system,
and wherein the at least one face mask is held suspended by the line in the location in space while the control system is in the non-operative condition,
and wherein the at least one face mask is displaceable away from the location in space by an application of a pulling force to tension the line to:
move the switch to energise the power circuit of the control system, thereby to activate the operative condition of the control system; and
move the opening mechanism, thereby to activate the flow of the breathable gas from the vessel.

4. A The system according to claim 1, comprising:
an electrical power unit including a power circuit; and
an electrical cable having a first portion connected to the power circuit and a second portion connected to the control system.

5. A The system according to claim 4, wherein:
the holder comprises a line for suspending the at least one face mask in the location in space; and
the activation device comprises:
an opening mechanism connected to a first portion of the line and arranged to open a valve part of the vessel;
a switch connected to a second portion of the line and arranged to engage the power circuit of the electrical power unit; and
a third portion of the line connected to the at least one face mask,
and wherein the at least one face mask is held suspended by the line in the location in space while the control system is in the non-operative condition,
and wherein the at least one face mask is displaceable away from the location in space by an application of a pulling force to tension the line to:
move the switch to energise the power circuit of the electrical power unit and the electrical cable, thereby to activate the operative condition of the control system; and
move the opening mechanism, thereby to activate the flow of the breathable gas from the vessel.

6. The system according to claim 4, wherein:
the holder comprises a line for suspending the at least one face mask in the location in space; and
the activation device comprises:
an electromechanical valve arranged to open the vessel and in electrical connection with the power circuit of the electrical power unit;
a switch connected to a first portion of the line and arranged to engage the power circuit of the electrical power unit; and
a second portion of the line connected to the at least one face mask,
and wherein the at least one face mask is held suspended by the line in the location in space while the control system is in the non-operative condition,
and wherein the at least one face mask is displaceable away from the location in space by an application of a pulling force to tension the line to move the switch, to energise the power circuit of the electrical power unit and the electrical cable and the electrical connection to the electromechanical valve, thereby to activate the operative condition of the control system and the flow of the breathable gas from the vessel.

7. The system according to claim 2, wherein:
the holder comprises a container for holding the at least one face mask in the location in space; and
the activation device comprises:
an opening mechanism connected to a first portion of a line and arranged to open a valve part of the vessel; and
a switch connected to a second portion of the line and arranged to engage the power circuit of the control system,
and wherein the at least one face mask is held by the container in the location in space while the control system is in the non-operative condition,
and wherein the at least one face mask is displaceable away from the location in space by an application of a pulling force to tension the line to:
move the switch to energise the power circuit of the control system, thereby to activate the operative condition of the control system; and
move the opening mechanism, thereby to activate the flow of the breathable gas from the vessel.

8. The system according to claim 4, wherein:
the holder comprises a container for holding the at least one face mask in the location in space; and
the activation device comprises:
an opening mechanism connected to a first portion of a line and arranged to open a valve part of the vessel;
a switch connected to a second portion of the line and arranged to engage the power circuit of the electrical power unit; and
a third portion of the line connected to the at least one face mask,
and wherein the at least one face mask is held by the container in the location in space while the control system is in the non-operative condition,
and wherein the at least one face mask is displaceable away from the location in space by an application of a pulling force to tension the line to:
move the switch to energise the power circuit of the electrical power unit and the electrical cable, thereby to activate the operative condition of the control system; and
move the opening mechanism, thereby to activate the flow of the breathable gas from the vessel.

9. The system according to claim 4, wherein:
the holder comprises a container for holding the at least one face mask in the location in space; and
the activation device comprises:
an electromechanical valve arranged to open the vessel and in electrical connection with the power circuit of the electrical power unit;
a switch connected to a first portion of a line and arranged to engage the power circuit of the electrical power unit; and
a second portion of the line connected to the at least one face mask,
and wherein the at least one face mask is held by the container in the location in space while the control system is in the non-operative condition,
and wherein the at least one face mask is displaceable away from the location in space by an application of a pulling force to tension the line to move the switch, to energise the power circuit of the electrical power unit and the electrical cable and the electrical connection to the electromechanical valve, thereby to activate the operative condition of the control system and the flow of the breathable gas from the vessel.

10. The system according to claim 3, wherein:
the line is configured to break under the application of the pulling force, so as to enable the displacement of the at least one face mask away from the location in space; and
a magnitude of the pulling force required to break the line is greater than a magnitude of the pulling force required to activate the operative condition of the control system and the flow of the breathable gas from the vessel,
so as to ensure the activation of the operative condition of the control system and the flow of the breathable gas by the displacement of the at least one face mask away from the location in space.

11. The system according to claim 10, wherein the line comprises a stronger portion having a higher ultimate tensile strength and a weaker portion having a lower ultimate tensile strength, the weaker portion being breakable under the application of the pulling force.

12. The system according to claim 1, comprising the vessel.

13. The system according to claim 1, wherein the breathable gas comprises oxygen, preferably pure oxygen.

14. The system according to claim 1, comprising a plurality of the face masks.

15. A face mask for use in a system according to claim 1, comprising:
the gas feed tube for connection to the vessel containing a supply of the breathable gas; and
the control system for controlling the flow of the breathable gas from the vessel when the gas feed tube is connected thereto and the control system is in an operative condition.
